(19) United States
(12) Patent Application Publication
(10) Pub. No.: US 2024/0143420 A1
(43) Pub. Date: May 2, 2024

(54) APPARATUS AND METHOD OF SUPPORTING COMMUNICATION TRANSACTIONS

(71) Applicant: SAMSUNG SDS CO., LTD., Seoul (KR)

(72) Inventors: Hyunwoo CHOO, Seoul (KR); Sungeun KIM, Seoul (KR)

(73) Assignee: SAMSUNG SDS CO., LTD., Seoul (KR)

(21) Appl. No.: 18/494,009

(22) Filed: Oct. 25, 2023

(30) Foreign Application Priority Data
Oct. 28, 2022 (KR) 10-2022-0141731

(51) Int. Cl. G06F 9/54

(52) U.S. Cl. CPC G06F 9/542; G06Q 20/42

(57) ABSTRACT

An apparatus for supporting business transactions including one or more processors configured to execute instructions and a memory storing the instructions, the execution of the instructions configures the one or more processors to receive a business process notification from a business system, the business process notification including one or business notification details and business process details, generate an app card based on the one of the business notification details and the business process notification, and transmit the app card to a messenger server, the app card being transmitted to a user terminal through the messenger server to be displayed using a messenger application of the user terminal and the generation of the app card being performed using standard data obtained by converting the one of the business notification details or the business process details included in the business process notification according to a preset standard format.

### CROSS-REFERENCE TO RELATED APPLICATION(S)

This application claims the benefit under 35 USC 119(a) of Korean Patent Application No. 10-2022-0141731 filed on Oct. 28, 2022 in the Korean Intellectual Property Office, the entire disclosure of which is incorporated herein by reference for all purposes.

### BACKGROUND

### 1. Field

The present disclosure relates to an apparatus and method of supporting business transactions.

### 2. Description of the Related Art

A business system may be accessed only in an office or work site, and when working outside or moving outside, access to work may be disconnected and delays occur.

Therefore, a method of processing work by developing a separate mobile application may be considered. However, it may require high costs to develop a separate mobile application, and therefore, in most cases, it is implemented only for tasks that should be handled externally due to high costs. Thus, most in-house systems are difficult to handle on mobile.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, here is provided an apparatus for supporting business transactions including one or more processors configured to execute instructions and a memory storing the instructions, the execution of the instructions configures the one or more processors to receive a business process notification from a business system, the business process notification including one or business notification details and business process details, generate an app card based on the one of the business notification details and the business process notification, and transmit the app card to a messenger server, the app card being transmitted to a user terminal through the messenger server to be displayed using a messenger application of the user terminal and the generation of the app card being performed using standard data obtained by converting the one of the business notification details or the business process details included in the business process notification according to a preset standard format.

The app card includes, as a card-type interface, one of a simple notification type app card, the simple notification type app card including only an area for displaying the business notification details and a business processing type app card, business processing type app card including a first area for displaying the business process details and a second area for implementing a processing function for the business process details.

The preset standard format may be a JavaScript Object Notation (JSON) format, and the standard data may include, in addition to the business notification details or the business process details, one or more of an environment, a content type, an app card ID, an ID of a transmission target messenger server, and an ID of a user receiving the app card.

The processing function may be implemented in a form of a button in the second area for implementing the processing function.

The instructions may include, when the app card is the business processing type app card, receiving processing details of a user from the user terminal through the messenger server, the processing details of the user including a click event of the button implemented in the area for implementing the processing function and transmitting the processing details of the user to the business system.

The instructions may include receiving a processing result from the business system, generating an app card based on the processing result, and transmitting the app card to the messenger server as the app card is transmitted to the user terminal through the messenger server to be displayed using the messenger of the user terminal.

In a general aspect, here is provided a method of supporting business transactions including receiving a business process notification from a business system, the business process notification including one of business notification details and business process details, generating an app card based on the one of the business notification details and the business process notification, and transmitting the app card to a messenger server, the app card being transmitted to a user terminal through the messenger server to be displayed using a messenger application of the user terminal, and the app card being generated using standard data obtained by converting the business notification details or the business process details according to a preset standard format.

The app card may include, as a card-type interface, one of a simple notification type app card including only an area for displaying the business notification details and a business processing type app card including a first for displaying the business process details and a second area for implementing a processing function for the business process details.

The preset standard format may be a JSON format and the standard data may include one or more of an environment, a content type, an app card ID, an ID of a transmission target messenger server, and an ID of a user receiving the app card, in addition to the business notification details or the business process details.

The processing function may be implemented in a form of a button in the second area for implementing the processing function.

When the app card is the business processing type app card, the method of supporting business transactions may include receiving processing details of a user from the user terminal through the messenger server, the processing details of the user including a click event of a button implemented in the area for implementing the processing function and transmitting the processing details of the user to the business system.

The method may include receiving a processing result from the business system, generating an app card based on the processing result, and transmitting the app card to the messenger server to be displayed using the messenger application of the user terminal.

In a general aspect, here is provided a non-transitory computer-readable storage medium storing instructions that, when executed by one or more processors, configure the one or more processors to perform operations including generating an app card based on a business process notification by converting one of business notification details or business process details included in the business process notification according to a preset standard format and transmitting the app card to a messenger server, the messenger server being configured to provide the app card to a terminal.

The terminal may display the app card through a messenger application.

The instructions may include receiving processing details of a user from the terminal through the messenger server.

The processing details may include a click event of a button provided in a display area for implementing a processing function.

The app card may include one of a notification type app card, the notification type app card including an area for displaying the business notification details and a business processing type app card including the display area to implement the processing function for the business process details and another display area to display the business process details.

The instructions may include transmitting the processing details of the user to a business system from which the business process notification was received.

The instructions may include receiving a processing result from the business system, generating an app card based on the processing result, and transmitting the app card to the messenger server, the app card being transmitted to the terminal through the messenger server to be displayed using the messenger of the terminal

The app card may include one of a notification type app card, the notification type app card including an area for displaying the business notification details and a business processing type app card including a first display area to display the business process details and a second display area to implement a processing function for the business process details.

### BRIEF DESCRIPTION OF DRAWINGS

FIG. 1 is a configuration diagram of a system including an apparatus for supporting business transactions according to an embodiment;

FIG. 2 is an example of a business processing type app card according to an embodiment;

FIG. 3 is an example of a notification type app card according to an embodiment;

FIG. 4 is an example of an app card generated based on a processing result according to an embodiment;

FIG. 5 is a flowchart including a method of supporting business transactions according to an embodiment; and

FIG. 6 is a block diagram of a computer device capable of fully or partially implementing an apparatus for supporting business transactions according to an embodiment.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

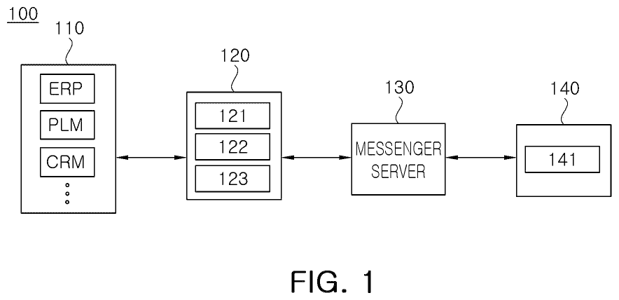

FIG. 1 is a configuration diagram of a system 100 including an apparatus 120 for supporting business transactions according to an embodiment, and the system 100 may include a business system 110, an apparatus 120 for supporting business transactions, a messenger server 130, and a user terminal 140.

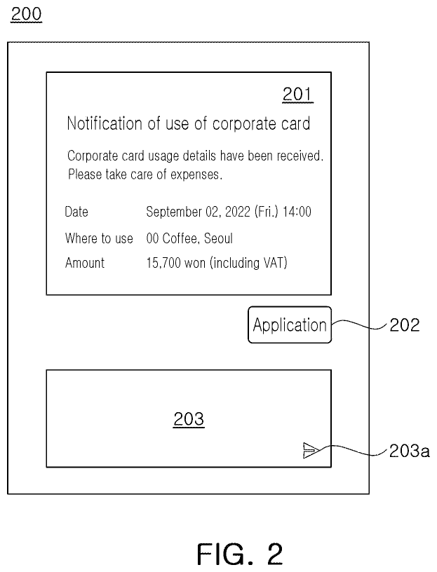

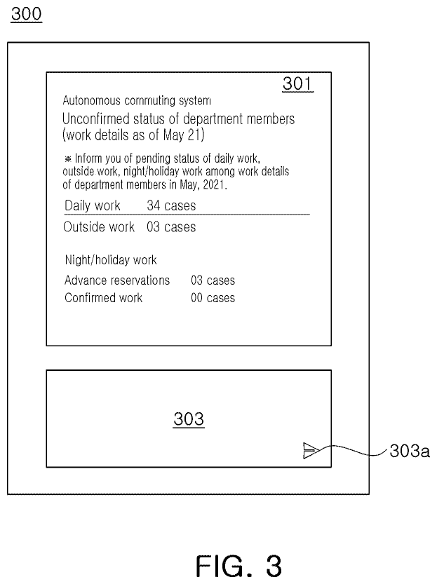

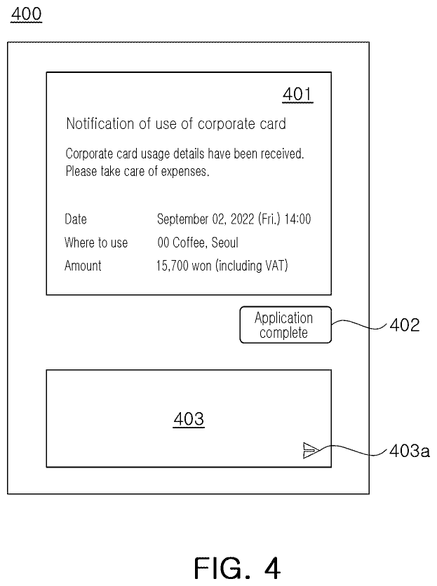

On the other hand, FIG. 2 is an example of a business processing type app card according to an embodiment. FIG. 3 is an example of a notification type app card according to an embodiment. FIG. 4 is an example of an app card generated based on a processing result according to an embodiment.

Hereinafter, with reference to FIGS. 1 to 4, the operation of the system 100 including the apparatus 120 for supporting business transactions according to an embodiment will be described.

As illustrated in FIG. 1, the business system 110 may include various business systems such as enterprise resource planning (ERP), a product lifecycle management (PLM) system, a customer relationship management (CRM) system, and the like.

This business system 110 may generate various business process notifications, and transmit the generated business process notification to the apparatus 120 for processing business transactions.

The above-mentioned business process notification may include business notification details and business process details.

The business process notification is simply for notifying the user, and may be, for example, the contents 301 described in the unconfirmed status of members of the department related to the autonomous commuting system illustrated in FIG. 3.

In addition, the business processing details require processing by the user, and may be, for example, the contents 201 described in the corporate card use notification illustrated in FIG. 2. In the case of this business process details, it may be a user process, for example, something that the user has to apply for by pressing an application button 202.

In addition, when the business system 110 receives the processing details of the user from the apparatus 120 for supporting business transactions, the business system 110 may perform predetermined processing, for example, payment, approval, etc., according to the received user processing details, and then transmit the processing result to the apparatus 120 for supporting business transactions.

In this case, the user processing details may refer to a click event of the button 202 implemented in an area for implementing a processing function in the case of the business processing type app card illustrated in FIG. 2 (to be described later).

On the other hand, the apparatus 120 for supporting business transactions may generate and transmit an app card. This apparatus 120 for supporting business transactions may include a receiver 121, an app card generator 122 and a transmitter 123.

In detail, the receiver 121 may receive a business process notification from the business system. In this case, as described above, the business process notification may include business notification details for simply informing the user or business process details to be processed by the user.

Next, the app card generator 122 may generate an app card based on the business process notification.

In detail, the app card generator 122 may generate an app card using standard data obtained by converting the business notification details or business process details included in the business process notification according to a preset standard format.

Then, the transmitter 123 may transmit the created app card to the messenger server 130. Then, the messenger server 130 transmits the app card to the user terminal 140, and the app card may be displayed using a messenger 141 installed in the user terminal 140.

In the present disclosure, an app card means a card-type interface, and may be a simple notification type app card 300 having an area 301 for displaying business notification details and a message window 303 having a send button 303a as illustrated in FIG. 3, or may be a business processing type app card 200 including an area 201 for displaying business process details, an area 202 for implementing the processing function for business process details, and a message window 203 having a send button 203a as illustrated in FIG. 2. Other above-mentioned simple notification type app card 300 or business processing type app card 200 may further include selectable buttons such as radio buttons, check box buttons or the like, and an event may also be selected by clicking these buttons, of course.

The above-described preset standard format may be a JSON format. Table 1 below illustrates standard data in an illustrative JSON format of the present disclosure.

```
TABLE 1
{
  “MessengerEnv”: prod”,//Development, operation
  “contentsType”:”appCard”,//Content Type
  “contentsId”:55cacb00=36ef-11ec-a247-ed96daaf729”,//Appcard ID
  “boltId”:”microappcard”,//Transmission Target Messenger ID
  “targetUserId”:”hyunwoo.choo”,//appCard receiving User
  “contentsParams”{//Content to be displayed on screen
    “Parameter”:”Value”
  }
}
```

As illustrated in Table 1 above, in addition to business notification details or business processing details (content to be displayed on the screen), the standard data may include the environment (development or operation), content type, app card ID, transmission target messenger ID, and ID of the user receiving the app card.

In addition, the above-described processing function may be implemented in the form of a button in the area 202 for implementing the processing function, as illustrated in FIG. 2.

On the other hand, in the case in which the app card is a business processing type app card as illustrated in FIG. 2, the receiver 121 may further receive processing details of the user from the user terminal 140 through the messenger server 130, and the transmitter may transmit the processing details of the user to the business system 110. The above-described processing details of the user may include a click event of a button implemented in the area 202 for implementing a processing function.

In addition, the receiver 121 further receives the processing result from the business system 110, and the app card generator 122 may further generate an app card based on the processing result.

An app card 400 based on the above processing result may be provided with an area 401 for displaying business process details, an area 402 for displaying the result of processing (e.g., application completion) by the business system 110, and a message window 403 with send button 403a as illustrated in FIG. 4.

Thereafter, the transmitter may transmit the app card generated based on the processing result to the messenger server 130, and the app card generated based on the processing result is transmitted to the user terminal 140 through the messenger server 130, to be displayed using the messenger 141 of the user terminal 140.

On the other hand, the messenger server 130 is a device provided between the apparatus 120 for supporting business transactions and the user terminal 140, to support transmission and reception of messages.

In detail, the messenger server 130 may receive an app card from the apparatus 120 for supporting business transactions, and transmit the received app card to the user terminal 140.

In addition, the messenger server 130 may receive the user processing details from the user terminal 140 and transmit the received user processing details to the apparatus 120 for supporting business transactions.

Also, the messenger server 130 may receive an app card generated based on a processing result from the apparatus 120 for supporting business transactions and may transmit the received app card to the user terminal 140.

In FIG. 1, it should be noted that internal blocks for implementing the functions of the messenger server 130, for example, a communication unit, a control unit and the like, are not separately illustrated.

In addition, the user terminal 140 may receive the app card generated based on the business process notification from the messenger server 130 and may display the received app card using the messenger 141. The aforementioned messenger 141 may be software capable of exchanging messages and data in real time over a network.

In addition, the user terminal 140 may receive an app card generated according to a processing result of the business system 110 from the messenger server 130 and display the received app card using the messenger 141.

In addition, in the case in which the app card is a business processing type app card as illustrated in FIG. 2, the user terminal 140 receives the user processing details using the messenger 141, and may transmit the input user processing details to the messenger server 130. As described above, the processing details of the user may include a click event of a button implemented in the area 202 for implementing the processing function.

In FIG. 1, only the messenger 141 is illustrated as an internal block of the user terminal 140, but it should be noted that essential components such as a communication unit, an input/output unit, and the like are not separately illustrated.

The above-described user terminal 140 may include, for example, a smart phone, a mobile phone, a laptop computer, a digital broadcasting terminal, a Personal Digital Assistant (PDA), a Portable Multimedia Player (PMP), a tablet PC, a desktop PC, and the like.

As described above, according to an embodiment, when a business process notification sent from the business system is received, by creating an app card using standard data converted from the received business process notification according to a preset standard format, various types of business process notifications may be provided as standardized app cards.

In addition, according to an embodiment, an app card generated based on a business process notification is transmitted to a user terminal through an existing messenger server, and in the user terminal, the processing details of the user are transmitted to the business system using the messenger server. Therefore, work efficiency may be improved by enabling work processing in a timely manner, and the cost of developing a separate mobile application may be reduced.

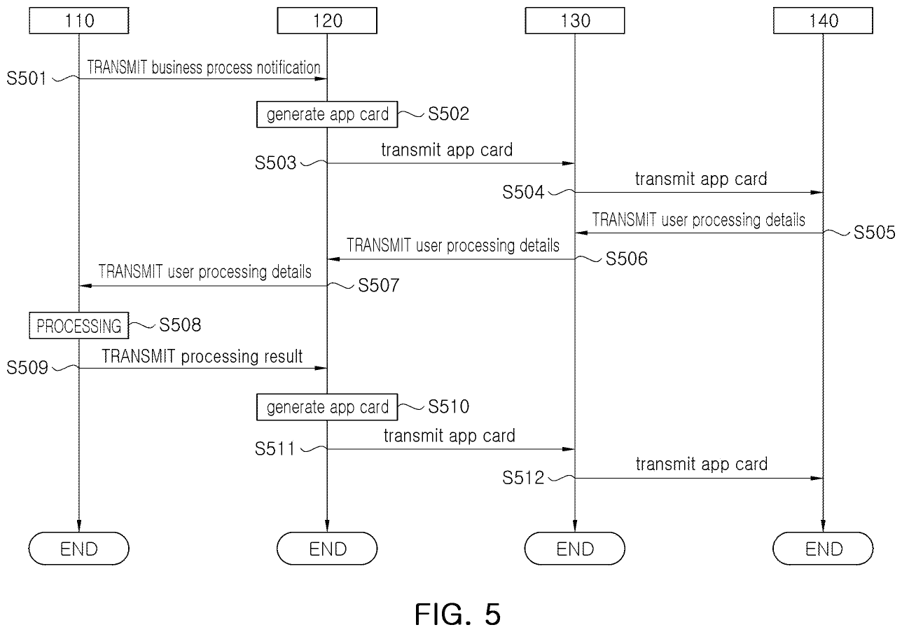

FIG. 5 is a flowchart including a method of supporting business transactions according to an embodiment.

Hereinafter, a flow chart including a method of supporting business transactions according to an embodiment will be described with reference to FIGS. 1 to 5. However, overlapping descriptions with those of FIGS. 1 to 4 are omitted for simplicity of descriptions.

Referring to FIGS. 1 to 5, first, the business system 110 may transmit a business process notification to the apparatus 120 for supporting business transactions (S501).

The above-described business process notification may include business notification details and business process details. The business process notification is simply for notifying the user, and may be, for example, the contents 301 described in the unconfirmed status of members of the department related to the autonomous commuting system illustrated in FIG. 3.

In addition, the business process details require processing by the user, and may be, for example, the contents 201 described in the corporate card use notice illustrated in FIG. 2. In the case of these business process details, it is the user process as described above, for example, in which the user may apply by pressing the application button 202.

Next, the apparatus 120 for supporting business transactions may generate an app card based on the business process notification (S502).

In detail, the app card generator 122 may generate an app card using standard data obtained by converting the business notification details or business process details included in the business process notification according to a preset standard format.

In the present disclosure, an app card means a card-type interface, and may be a simple notification type app card having an area 301 for displaying business notification details and a message window 303 having a send button 303a as illustrated in FIG. 3, or may be a business processing type app card having an area 201 for displaying business process details, an area 202 for implementing a processing function for the business process details, and a message window 203 having a send button 203a as illustrated in FIG. 2. In addition, the above-described preset standard format may be a JSON format as described above.

Thereafter, the apparatus 120 for supporting business transactions may transmit the generated app card to the messenger server 130 (S503). Then, the messenger server 130 transmits the app card to the user terminal 140 (S504), and the app card may be displayed using the messenger 141 installed in the user terminal 140.

Thereafter, the user terminal 140 may receive the user processing details using the messenger 141 and transmit the input user processing details to the messenger server 130 (S505). As described above, the processing details of the user may include a click event of a button implemented in an area for implementing a processing function.

Next, the messenger server 130 may receive the user processing details from the user terminal 140 and transmit the received user processing details to the apparatus 120 for supporting business transactions (S506). Thereafter, the apparatus 120 for supporting business transactions may transmit the processing details of the user to the business system 110 (S507).

Next, when the business system 110 receives the user processing details from the apparatus 120 for supporting business transactions, the business system 110 may perform predetermined processing, for example, payment, approval, and the like according to the received user processing details (S508), and may then transmit the processing result to the apparatus 120 for supporting business transactions (S509).

In this case, the processing details of the user may refer to the click event of the button 202 implemented in the area for implementing the processing function in the case of the business processing type app card (described later) illustrated in FIG. 2, as described above.

Thereafter, the app card generator 122 may generate an app card based on the processing result (S510), and transmit the app card generated based on the processing result to the messenger server 130 (S511).

As illustrated in FIG. 4, the app card based on the above-described processing results includes an area 401 for displaying business process details, an area 402 for displaying processing results (e.g., application completion) by the business system 110, and a message window 403 with send button 403a, as described above.

Thereafter, the messenger server 130 may transmit the app card generated based on the processing result to the user terminal 140 (S512), and then the app card may be displayed on the user terminal 140.

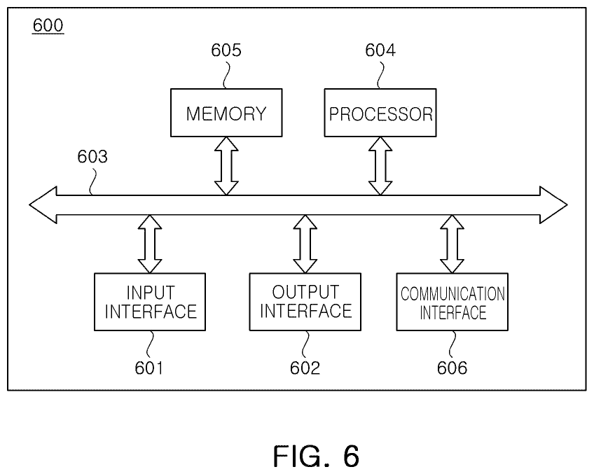

On the other hand, FIG. 6 is a block diagram of a computer device that may fully or partially implement the apparatus for supporting business transactions according to an embodiment, which may be applied to the business system 110, the messenger server 130, and the user terminal 140, of course, in addition to the apparatus 120 for supporting business transactions illustrated in FIG. 1.

As illustrated in FIG. 6, a computer device 600 includes an input interface 601, an output interface 602, a processor 604, a memory 605 and a communication interface 606, and the input interface 601, the output interface 602, the processor 604, the memory 605 and the communication interface 606 may be interconnected through a system bus 603.

In an embodiment, the memory 605 is used to store programs, instructions or code, and the processor 604 may execute a program, command or code stored in the memory 605, control the input interface 601 to receive a signal, and control the output interface 602 to transmit a signal. The aforementioned memory 605 may include read-only memory and random access memory, and may provide instructions and data to the processor 604.

In an embodiment, the processor 604 may be a central processing unit (CPU), and it should be understood that the processor 604 may be other general-purpose processors, digital signal processors (DSPs), application specific integrated circuits (ASICs), field programmable gate arrays (FPGAs) or other programmable logic devices, discrete gates or transistor logic devices, individual hardware components, or the like. A general purpose processor may be a microprocessor, or the processor may be any processor of the related art or the like.

In an implementation process, the method performed in each of the devices 110, 120, and 130 of FIG. 1 may be obtained by an integrated logic circuit of hardware in the processor 604 or an instruction in the form of software. Contents of a method provided in relation to an embodiment of the present disclosure may be implemented to be performed and completed by a hardware processor or a combination of hardware and software modules of a processor to be performed and completed. The software module may be disposed in a storage medium such as random access memory, flash memory, read-only memory, programmable read-only memory or electrically erasable programmable memory, registers, or the like. The storage medium is located in the memory 605, and the processor 604 reads the information of the memory 605 and implements the contents of the above method in combination with hardware. To avoid duplication, detailed descriptions are omitted herein.

In addition, in describing the present disclosure, ‘− unit’ may be implemented in various manners, for example, by a processor, program instructions executed by the processor, software modules, microcodes, computer program products, logic circuits, application-specific integrated circuits, firmware, or the like.

As set forth above, according to an embodiment, when a business process notification sent from the business system is received, an app card may be generated using standard data converted from the received business process notification according to a preset standard format, thereby providing various types of business process notifications by standardized app cards.

In addition, according to an embodiment, an app card generated based on a business process notification is transmitted to a user terminal through an existing messenger server, and in the user terminal, processing details of the user are transmitted to the business system using a messenger server. Accordingly, work efficiency may be improved because work may be processed in a timely manner, and costs required for developing a separate mobile application may be reduced.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for supporting business transactions comprising:
one or more processors configured to execute instructions; and
a memory storing the instructions, wherein execution of the instructions configures the one or more processors to:
receive a business process notification from a business system, the business process notification including one or business notification details and business process details;
generate an app card based on the one of the business notification details and the business process notification; and
transmit the app card to a messenger server,
wherein the app card is transmitted to a user terminal through the messenger server to be displayed using a messenger application of the user terminal, and
wherein the generation of the app card is performed using standard data obtained by converting the one of the business notification details or the business process details included in the business process notification according to a preset standard format.

2. The apparatus of claim 1, wherein the app card includes, as a card-type interface, one of:
a simple notification type app card, the simple notification type app card including only an area for displaying the business notification details, and
a business processing type app card, business processing type app card including a first area for displaying the business process details and a second area for implementing a processing function for the business process details.

3. The apparatus of claim 1, wherein the preset standard format is a JavaScript Object Notation (JSON) format, and
wherein the standard data includes, in addition to the business notification details or the business process details, one or more of an environment, a content type, an app card ID, an ID of a transmission target messenger server, and an ID of a user receiving the app card.

4. The apparatus of claim 2, wherein the processing function is implemented in a form of a button in the second area for implementing the processing function.

5. The apparatus of claim 4, wherein, the instructions further comprise, when the app card is the business processing type app card:
receiving processing details of a user from the user terminal through the messenger server, the processing details of the user including a click event of the button implemented in the area for implementing the processing function; and
transmitting the processing details of the user to the business system.

6. The apparatus of claim 5, wherein the instructions further comprise:
receiving a processing result from the business system;
generating an app card based on the processing result; and
transmitting the app card to the messenger server,
wherein the app card is transmitted to the user terminal through the messenger server to be displayed using the messenger of the user terminal.

7. A method of supporting business transactions, the method comprising:
receiving a business process notification from a business system, the business process notification including one of business notification details and business process details;
generating an app card based on the one of the business notification details and the business process notification; and
transmitting the app card to a messenger server,
wherein the app card is transmitted to a user terminal through the messenger server to be displayed using a messenger application of the user terminal, and
wherein the app card is generated using standard data obtained by converting the business notification details or the business process details according to a preset standard format.

8. The method of claim 7, wherein the app card includes, as a card-type interface, one of:
a simple notification type app card including only an area for displaying the business notification details; and
a business processing type app card including a first for displaying the business process details and a second area for implementing a processing function for the business process details.

9. The method of claim 7, wherein the preset standard format is a JSON format, and
wherein the standard data includes one or more of an environment, a content type, an app card ID, an ID of a transmission target messenger server, and an ID of a user receiving the app card, in addition to the business notification details or the business process details.

10. The method of claim 8, wherein the processing function is implemented in a form of a button in the second area for implementing the processing function.

11. The method of claim 10, wherein, when the app card is the business processing type app card, the method of supporting business transactions further includes:
receiving processing details of a user from the user terminal through the messenger server, the processing details of the user including a click event of a button implemented in the area for implementing the processing function; and
transmitting the processing details of the user to the business system.

12. The method of claim 11, wherein the method of further comprises:
receiving a processing result from the business system;
generating an app card based on the processing result; and
transmitting the app card to the messenger server to be displayed using the messenger application of the user terminal.

13. A non-transitory computer-readable storage medium storing instructions that, when executed by one or more processors, configure the one or more processors to perform:
generate an app card based on a business process notification by converting one of business notification details or business process details included in the business process notification according to a preset standard format; and
transmit the app card to a messenger server, the messenger server being configured to provide the app card to a terminal.

14. The computer-readable storage medium of claim 13, wherein the terminal displays the app card through a messenger application.

15. The computer-readable storage medium of claim 14, wherein the instructions comprise:
receiving processing details of a user from the terminal through the messenger server.

16. The computer-readable storage medium of claim 15, wherein the processing details include a click event of a button provided in a display area for implementing a processing function.

17. The computer-readable storage medium of claim 16, wherein the app card includes one of:
a notification type app card, the notification type app card including an area for displaying the business notification details; and
a business processing type app card including the display area to implement the processing function for the business process details and another display area to display the business process details.

18. The computer-readable storage medium of claim 15, wherein the instructions further comprise:
transmitting the processing details of the user to a business system from which the business process notification was received.

19. The computer-readable storage medium of claim 18, wherein the instructions further comprise:
receiving a processing result from the business system;
generating an app card based on the processing result; and
transmitting the app card to the messenger server,
wherein the app card is transmitted to the terminal through the messenger server to be displayed using the messenger of the terminal.

20. The computer-readable storage medium of claim 13, wherein the app card includes one of:
a notification type app card, the notification type app card including an area for displaying the business notification details; and
a business processing type app card including a first display area to display the business process details and a second display area to implement a processing function for the business process details.
